(19) United States
(12) Patent Application Publication
(10) Pub. No.: US 2010/0212269 A1
(43) Pub. Date: Aug. 26, 2010

(54) CANINE RESCUE HARNESS

(76) Inventor: Lucia Santa DELL'AGNESE, Toronto (CA)

Correspondence Address: BENNETT JONES LLP, 3400 ONE FIRST CANADIAN PLACE, PO BOX 130, TORONTO, ON, M5X 1A4, CA

(21) Appl. No.: 12/392,627

(22) Filed: Feb. 25, 2009

(51) Int. Cl. B68C 1/00; A01K 27/00

(52) U.S. Cl. 54/37.1; 119/858; 119/859

(57) ABSTRACT

A canine harness for search and rescue dogs comprising a body configured for fitting on a canine, one or more receptacles for receiving items, and one or more magnetic fasteners configured for securing the harness to the canine and the magnetic fasteners being configured for disengaging if an external force is applied to the harness. The receptacles may be used to carry items into the rescue environment such as one or more cameras for transmitting images to another location, a power supply to power the cameras, a light sensor for sensing light in the dog's environment and a light for providing illumination in low light rescue situations. The body may include a separating zipper that can be closed with any one of a plurality of rows of alternating receiving teeth such that the harness can be fitted to canines of various sizes.

### FIELD OF THE APPLICATION

The present application relates to canine garments, and more particularly, a canine rescue harness suitable for search and rescue dogs.

### BACKGROUND OF THE APPLICATION

Search and rescue dogs often work in rugged and dangerous conditions and are confronted with unsafe situations on a regular basis. They are trained to find live people who are trapped in the aftermath of a disaster, such as the structural collapse of an occupied building. Search and rescue dogs are commonly used as the fastest and most reliable means of finding people in the rubble.

To expedite search and rescues, it would be desirable to fit a search and rescue dog with video and sensing equipment. This would help first responders see and hear what the dog sees and hears, and know where the dog is during a search so that first responders could provide immediate assistance to trapped people who have been found by the dog.

However, as rubble is typically a disorganized mass of debris, there is a great risk of dogs becoming trapped in the rubble by worn items, such as a collar or harness. As a result, searches are being conducted without any functional apparel being worn by the dog.

Accordingly, there remains a need for improvements in the art.

### BRIEF SUMMARY OF THE INVENTION

According to one aspect, the present invention provides a canine harness which allows the dog to carry items to assist the search and rescue operation and also allows the dog to escape the harness should the harness become caught on an object in the rescue environment.

According to one embodiment, the present invention provides a canine harness comprising a body configured for fitting on a canine; one or more receptacles for receiving items; and one or more magnetic fasteners configured for securing the harness to the canine and the magnetic fasteners being configured for disengaging if an external force is applied to the harness.

According to another embodiment, a canine harness comprising a body configured for fitting on a canine; one or more receptacles for receiving items; and three or more magnetic fasteners configured for securing the harness to the canine and the magnetic fasteners being configured for disengaging if an external force is applied to the harness.

Other aspects and features according to the present application will become apparent to those ordinarily skilled in the art upon review of the following description of embodiments of the invention in conjunction with the accompanying figure.

### BRIEF DESCRIPTION OF THE DRAWINGS

Reference will now be made to the accompanying drawings which show, by way of example, embodiments of the invention, and how they may be carried into effect, and in which:

FIG. 1 shows a side view of an embodiment of the invention in use;

FIG. 2 is an unfolded view of the interior of the embodiment of the harness shown in FIG. 1;

FIG. 3 is a side view of the embodiment of the invention shown in FIG. 1;

FIG. 4 is a front view of the embodiment of the invention shown in FIG. 1;

FIG. 5 is a top view of the embodiment of the invention shown in FIG. 1; and

FIG. 6 is a bottom view of the embodiment of the invention shown in FIG. 1.

Like reference numerals indicate like or corresponding elements in the drawings.

### DETAILED DESCRIPTION OF THE EMBODIMENTS

Embodiments of the present invention are generally directed to a canine harness which allows the dog to carry items to assist the search and rescue operation and also allows the dog to escape the harness should the harness become caught on an object in the rescue environment.

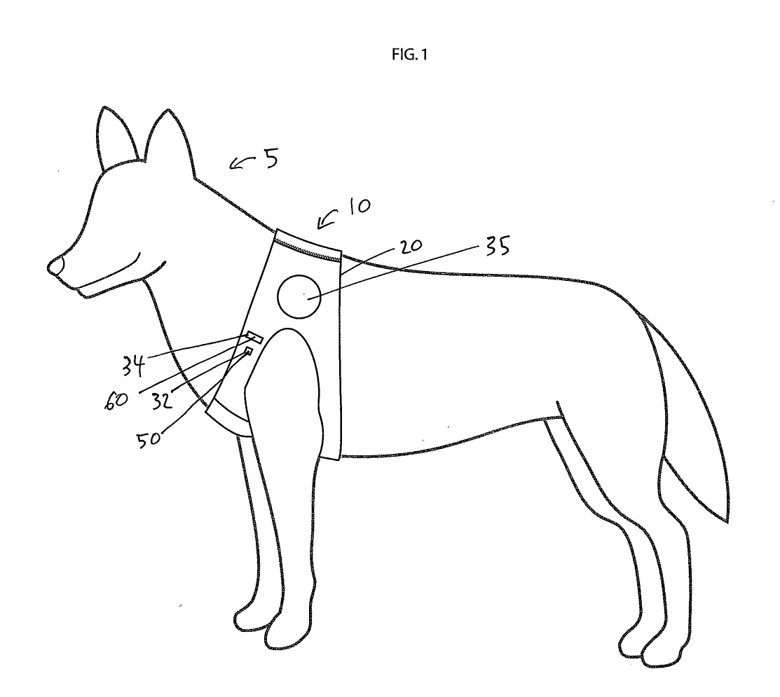

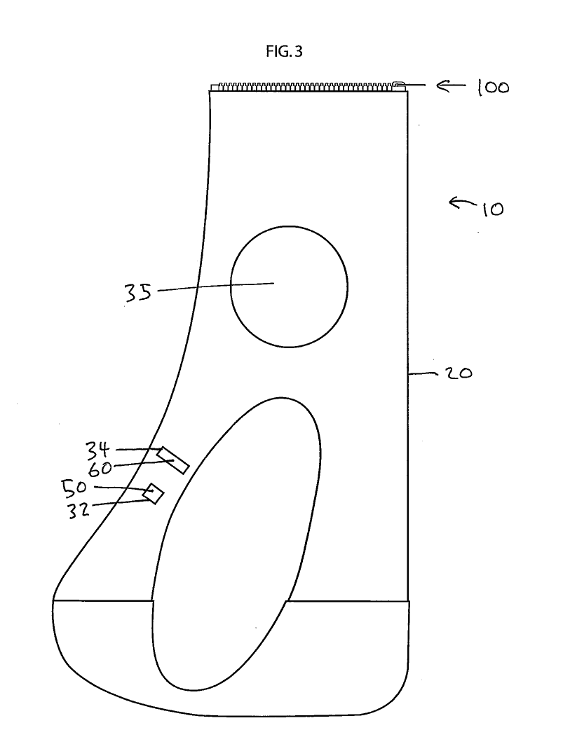

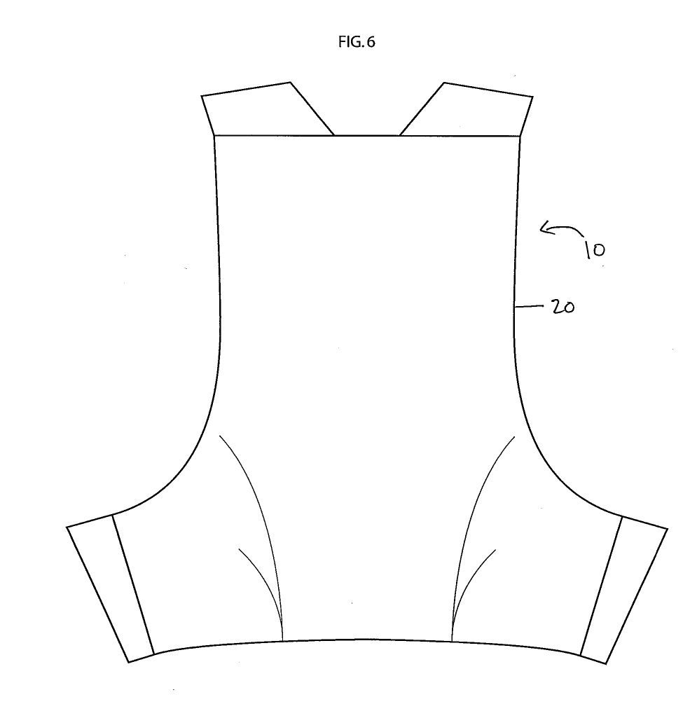

According to an embodiment shown in FIG. 1, a canine or dog 5 wears canine rescue harness 10. FIGS. 3 and 6 show respective side and bottom views of the harness 10, and like reference numerals indicate like elements. According to an embodiment, the body 20 of the rescue harness 10 is made of a lightweight, durable fabric such as a canvas-type nylon material, which may include a slightly rubberized backing. Alternatively, the body 20 is made of any lightweight fabric which will reduce any overheating of the dog caused by wearing the harness 10, including elastomeric materials, such as lycra™ or spandex, or elastomeric-blended materials that may better adapt to fitting different-sized dogs 5. The body 20 is fitted to the dog's chest and torso and provides openings for the dog's two front legs. According to an embodiment, the body 20 is fitted to cover the least amount of area on the dog as needed to secure whatever items are required for the search and rescue operation, so as to minimize overheating of the dog 5 caused by wearing the harness 10. A close fit of the body 20 to the dog 5 may better prevent the harness 10 from getting caught on protruding debris.

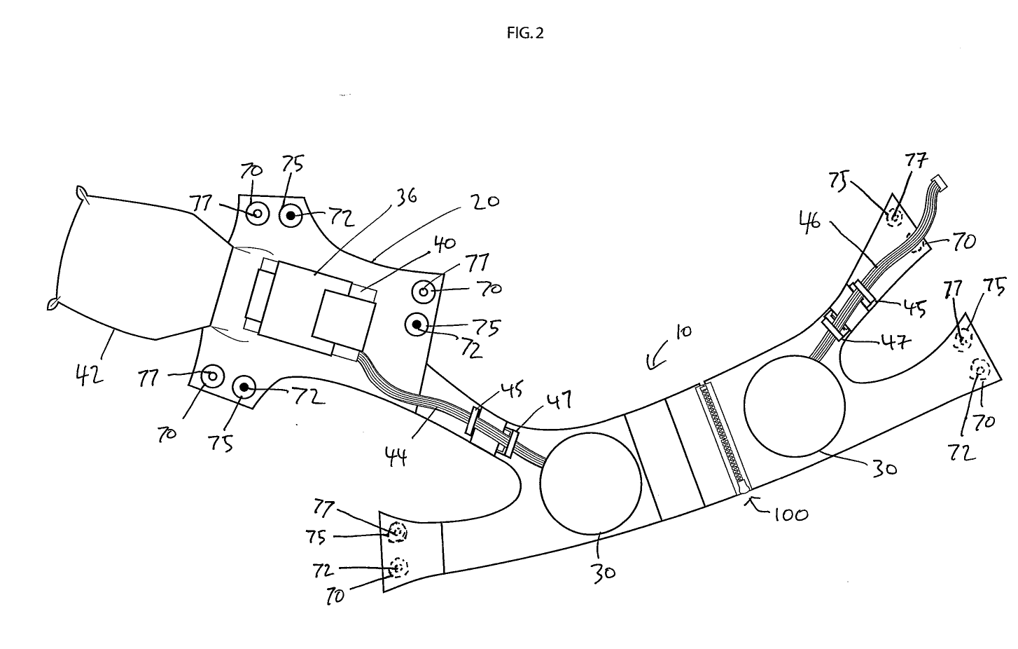

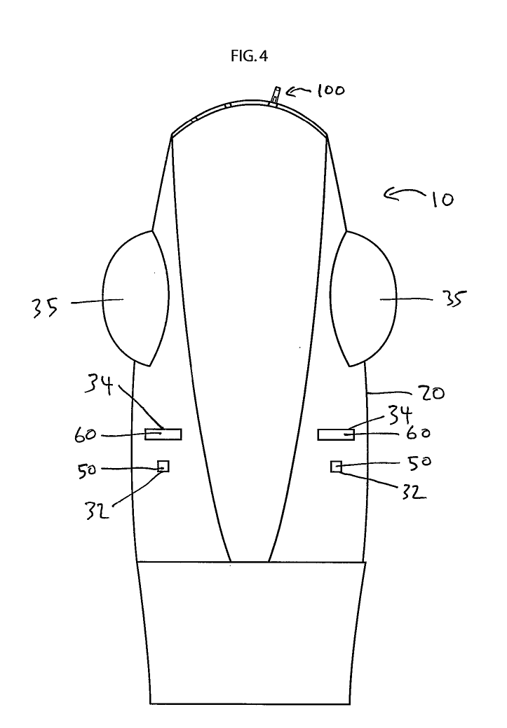

As shown in the embodiments in FIG. 1 and FIG. 2, the harness 10 includes one or more receptacles for securing or receiving items such as pouches 30, 32, 34 and 36. Each of pouches 30, 32, 34 and 36 allows the items secured therein to be kept close to the dog's body, which may reduce their chance of being damaged during a search and rescue operation. Pouch 30, as shown, secures a camera 35 which is positioned on the dog's shoulder and includes a snap closure. Not shown in FIG. 1, but shown in FIG. 2 is that a camera 35 is also secured in a pouch 30 on the dog's opposite shoulder. Pouch 32 includes a light sensor 50 which is used to sense the amount of light in the dog's environment. Pouch 34 includes a light 60 which is used to illuminate the dog's environment. According to an embodiment, a control signal is provided from the light sensor 50 to the light 60 such that the amount of light output by light 60 is responsive to the amount of light sensed by the light sensor 50. In other words, no light is output in well-light rescue environments and much light is output in dark rescue environments. As shown in FIG. 4, pouches 32 and 34, light sensor 50 and light 60 may be included on both sides of the harness 10 so as to be positioned on the front part of each of the dog's shoulders when the harness 10 is in use. Other items may be secured to the body 20 through the use of receptacles, such as pouches, as would be known to a person skilled in the art. A close-fitting body 20 to the dog 5 may provide stability for any sensing components worn by the dog 5.

According to an embodiment, the cameras 35, light sensor 50 and light 60 have internal power sources, as needed. According to a further embodiment, one or more of the items, such as cameras 35, require an external power source. According to this embodiment, pouch 36 is provided to secure power supply 40. This pouch may include a snap closure and/or a hook and loop closure, or any other suitable closure, to substantially enclose the power supply 40. When the harness 10 is equipped to the dog 5 according to this embodiment, the power supply 40 is against the chest of the dog 5. Since the power supply 40 generates heat, a heat shield 42, such as made from rip-stop nylon or any other heat-resistant fabric such as nomex or combinations of such fabrics, is provided to reduce the heat transferred from the power supply 40 to the dog 5. Pouches 30, 32, 34 and 36 may also be made from rip-stop nylon, or other light and strong fabrics, according to an embodiment. The power supply 40 is connected to any items requiring power, such as cameras 35, through the use of wires 44 and 46 which are routed through and secured by loops 45 and 47.

Turning to the embodiment shown in FIG. 2, there are magnetic fasteners 70, 75. As known in the art, magnetic fasteners 70, 75 comprise pairs of magnets of opposite polarity. FIG. 2 shows magnets in dashed lines which are on the reverse side of the body 20 and fasten to the magnets on the visible side of the body 20 according to this view to form magnetic fasteners 70, 75. The magnetic fasteners 70, 75 are configured or selected to provide a suitable magnetic force for securing the harness 10 to the canine. The magnetic fasteners 70, 75 are also configured to detach or disengage when a force is applied to the harness 10, for example, a tugging force if the harness 10 becomes entangled or caught on something. This arrangement allows the dog 5 to escape the harness 10 when it is caught upon an object, or otherwise restricted from moving by the harness 10, without any human, or other, assistance. According to an embodiment, the magnetic fasteners are positioned on the harness 10 as shown in FIG. 2 to allow the dog 5 to independently free itself when caught upon protruding debris without struggling.

According to an embodiment, there are sets of two or more proximate magnetic fasteners. The use of two or more proximate magnetic fasteners as a set functions to reduce the chance that the magnetic fasteners will spin or pivot. According to another embodiment, the set of two or more proximate magnetic fasteners comprise alternating polarities on the same side of the harness 10 being secured. The use of alternating polarities on the same side of the harness 10 can increase the hold of the proximate magnetic fasteners.

According to a further embodiment, the magnetic fasteners 70 and 75 include a first portion including a stud 72 and having a polarity and a second portion including a hole 77 for receiving the stud 72 and having the opposite polarity. The use of a complementary stud and hole pairing for a magnetic fastener prevents the magnetic fastener from being slid apart as opposed to pulled apart, and may increase the amount of force necessary to separate the magnetic fastener once fastened.

According to the embodiment shown in FIG. 2, there are three sets of pairs of complementary stud-hole magenetic fasteners. The use of three sets of pairs of magnetic fasteners allows for the possibility that only one set of magnetic fasteners need be detached in order for the dog 5 to be free from whatever was hindering the dog's movement. The remaining sets of magnetic fasteners would keep the harness 10 on the dog 5.

According to this embodiment, the use of three sets of magnetic fasteners also allows the dog to disengage from the harness 10 while still keeping the harness as one piece since one of the four branches of the body 20 which run down the dog's torso around the legs does not detach.

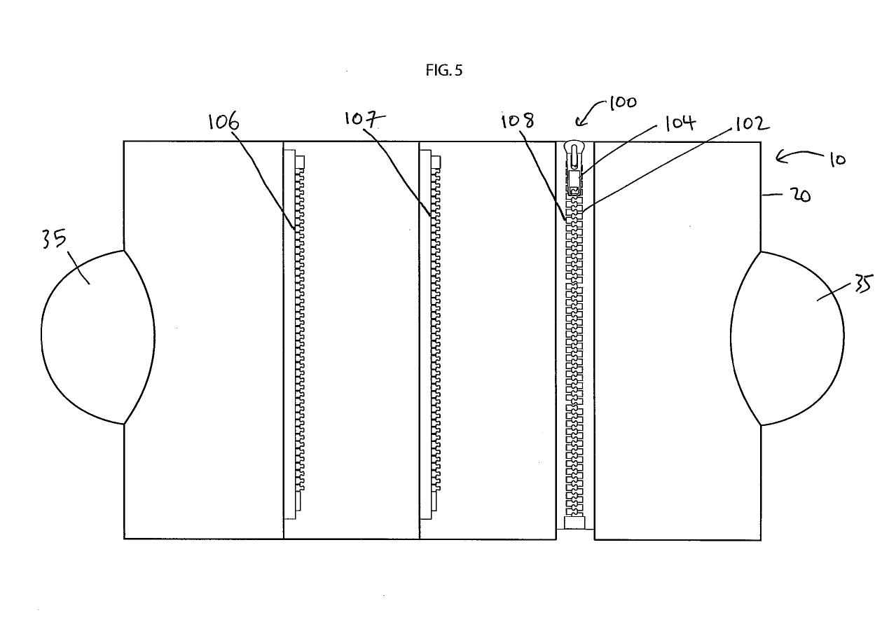

According to an embodiment, the harness 10 includes a zipper 100, as shown in FIG. 5, which secures the harness 10 to the dog 5. According to an embodiment, the zipper 100 comprises a zipper slider 104 that is at the end closest to the tail of the dog 5 when the zipper 100 is closed. This reduces the possibility that the dog 5 can partially open the zipper 100 through moving its head. According to an embodiment, the zipper 100 is a separating zipper. According to a further embodiment, the separating zipper comprises a row of teeth 102 and a zipper slider 104 that may be joined to one of a plurality of rows of alternating teeth. According to a further embodiment, there are three rows of alternating teeth—one row 106 to allow the harness 10 to fit smaller dogs, a second row 107 to allow the harness 10 to fit medium-sized dogs, and a third row 108 to allow the harness 10 to fit larger dogs. Due to the use of magnetic fasteners described above, the inclusion of the zipper 100 is not strictly necessary for the purpose of securing the harness 10 to the dog 5. However, the inclusion of the zipper 100 makes it easier to secure the harness 10 to the dog 5 and, as described above, allows the harness 10 to be adjustable to fit varying sizes of rescue dogs.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A canine harness comprising:
a body configured for fitting on a canine;
one or more receptacles for receiving items; and
one or more magnetic fasteners configured for securing the harness to the canine and the magnetic fasteners being configured for disengaging if an external force is applied to the harness.

2. The canine harness of claim 1, further comprising a zipper on the body for securing the harness to the canine.

3. The canine harness of claim 2, wherein the zipper is a separating zipper.

4. The canine harness of claim 3, wherein the separating zipper comprises a row of teeth and a zipper slider that may be joined to one of a plurality of rows of alternating teeth.

5. The canine harness of claim 2, wherein the zipper comprises a zipper slider that is at the end closest to the tail of the canine when the zipper is closed.

6. The canine harness of claim 1, wherein the items include a first camera configured to transmit images.

7. The canine harness of claim 6, wherein the items include a second camera configured to transmit images.

8. The canine harness of claim 7, wherein the receptacles for the respective first and second cameras are positioned on opposite shoulders of the harness.

9. The canine harness of claim 6, wherein the items include a power supply.

10. The canine harness of claim 1, wherein the items include a power supply.

11. The canine harness of claim 1, wherein the items include a light sensor.

12. The canine harness of claim 1, wherein the items include a light.

13. The canine harness of claim 11, wherein the items include a light that is configured to be responsive to the amount of light sensed by the light sensor.

14. The canine harness of claim 1, wherein the magnetic fasteners comprise a set of two or more proximate magnetic fasteners.

15. The canine harness of claim 14, wherein the set of two or more proximate magnetic fasteners comprise alternating polarities on the same side of the harness being secured.

16. The canine harness of claim 1, wherein at least one of the one or more magnetic fasteners comprises a first portion including a stud and having a polarity and a second portion including a hole for receiving the stud and having the opposite polarity.

17. A canine harness comprising:
a body configured for fitting on a canine;
one or more receptacles for receiving items; and
three or more magnetic fasteners configured for securing the harness to the canine and the magnetic fasteners being configured for disengaging if an external force is applied to the harness.

18. The canine harness of claim 17, wherein the magnetic fasteners comprise a set of two or more proximate magnetic fasteners.

19. The canine harness of claim 18, wherein the set of two or more proximate magnetic fasteners comprise alternating polarities on the same side of the harness being secured.

20. The canine harness of claim 17, wherein at least one of the three or more magnetic fasteners comprises a first portion including a stud and having a polarity and a second portion including a hole for receiving the stud and having the opposite polarity.
